(19) United States
(12) Patent Application Publication
(10) Pub. No.: US 2009/0276799 A1
(43) Pub. Date: Nov. 5, 2009

(54) Pickup Head Transmitting Mechanism of Disc Drive

(75) Inventors: Chih-Chung Hsieh, Hsinchu (TW); Ta-Hsiang Wang, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/263,582

(22) Filed: Nov. 3, 2008

(30) Foreign Application Priority Data
May 5, 2008 (CN) 200810096715.6

(51) Int. Cl. G11B 7/00

(52) U.S. Cl. 720/658; G9B/7

(57) ABSTRACT

A pickup head transmitting mechanism of a disc drive is provided. The pickup head transmitting mechanism has at least a guide rod, a thread rod, and a transmitting unit. The guide rod is utilized for supporting the pickup head of the disc drive. The thread rod is utilized for driving the pickup head along the guide rod. The transmitting unit is assembled between the pickup head and the thread rod and has a seat and a movable element. Wherein, the seat is fixed on the pickup head and has at least a sliding way extending toward the thread rod, and the movable element is slidably assembled in the sliding way and has a rack located on a surface thereof facing the thread rod. The rack is engaged with the thread rod.

### BACKGROUND OF THE INVENTION

(1) Field of the Invention

This invention relates to a pickup head transmitting mechanism of a disc drive, and more particularly relates to a pickup head transmitting mechanism driven by a thread rod.

(2) Description of the Prior Art

Most disc drives in present adopts stepping motors as power source for driving pickup head doing seeking movements. A transmitting mechanism is demanded for the stepping motor to transmit rotational movements into linearly movements to drive the pickup head. Therefore, the design of the transmitting mechanism affects the smoothness of seeking movements and dominates reading and writing ability of the pickup head.

FIG. 1 is a schematic view of a typical pickup head transmitting mechanism 100. As shown, the pickup head transmitting mechanism 100 has a thread rod 120 and a transmitting unit 140. The transmitting unit 140 is assembled between the pickup head 200 and the thread rod 120, and is utilized for transforming rotational movements of the thread rod 120 into linearly movements to drive the pickup head 200. Also referring to FIG. 2, the transmitting unit 140 has a main body 142, a flexible arm 144, and a rack 146, and is usually fabricated as a whole by using plastic materials. The main body 142 has a fixing hole 142a thereon for fixing the transmitting unit 140 on the pickup head 200. The threads of the rack 146 is engaged in the thread rod 120. The elastic arm 144 is utilized for connecting the main body 142 and the rack 146. Thereby, the power of a stepping motor is transmitted through the thread rod 120 and the transmitting unit 140 to drive the pickup head 200.

The elastic arm 144 connecting the main body 142 and the rack 146 shows a U-shaped structure and is thin-wall designed so as to reduce the force needed for bending the elastic arm 144. In addition, the elastic arm 144 also provides a retraction space between the rack 146 and the main body 142. Thereby, the size of the transmitting unit 140 can be shrunk by bending the rack 146 toward the main body 142 so as to facilitate the assembling process. In addition, to ensure the engagement between the rack 146 and the thread rod 120, referring to FIG. 2, a compressed spring 146, which is assembled by the elastic arm 144 and interposed between the main body 142 and the rack 146, is demanded for applying a preload to the rack 146 to guarantee the power of the stepping motor can be used to drive the pickup head 200.

However, referring to FIG. 3, because of transportation vibration or assembling mistakes, thread on the rack 146 may be escaped from the thread rod 120, a distance between the rack 146 and the main body 142 is reduced, and the elastic arm 144 is over-bended. Because the transmitting unit 140 is fabricated by using plastic materials, if the elastic arm 144 suffers an overwhelming deformation or a lasting elastic deformation, permanent deformation may be happened on the elastic arm 144. As a result, the rack 146 could not back to its original position to mesh the thread rod 120 and the seeking function of the pickup head 200 may be lost.

In addition, although the compressed spring 148 of FIG. 2 is capable of providing the preload forcing the rack 146 meshing the thread rod 120, the stiffness of the compressed spring 148 is usually smaller than that of the elastic arm 144. That is, the compressed spring 148 does not have enough stiffness to overcome the deformation of the elastic arm 144 and prevent the rack 146 from escaping the thread rod 120. In order to prevent the rack 146 from escaping the thread rod 120, an applicable method is to reduce the gap between the rack 146 and the main body 142 so as to restrict the retraction distance of the rack 146 smaller than the thread depth of the thread rod 120. However, a smaller gap implies an enhancement of fabrication difficulty during injection molding process and the increasing of attrition rate of the mold.

Referring to FIG. 4, another method is to implement an elastic plate 149 by the elastic arm 144 to restrict the retraction distance of the rack 146 so as to prevent the rack 146 from escaping the thread rod 120. However, the elastic plate 149 also restricts the deformation of the elastic arm 144. Therefore, the elastic arm 144 may be broken when an impact is applied to the transmitting unit 140 because the elastic arm 144 lacks the ability to absorb the impact by deformation.

Accordingly, it is demanded for persons in the art to find out a method to prevent the rack 146 from escaping the thread rod 120 to result in permanent deformation on the elastic arm 144 so as to ensure the seeking function of the pickup head 200.

### SUMMARY OF THE INVENTION

It is a main object of the present invention to provide a pickup head transmitting mechanism, which prevents the elastic arm thereof from being permanently deformed to influence the seeking function of the pickup head.

It is another object of the present invention to provide a pickup head transmitting mechanism, which prevents the side effect of the typical method adopting the elastic plate to restrict retraction distance of the rack that the elastic arm would be broken by the impact.

A pickup head transmitting mechanism of a disc drive is provided in the present invention. The pickup head transmitting mechanism has at least a guide rod, a thread rod, and a transmitting unit. The guide rod is utilized for supporting the pickup head of the disc drive. The thread rod is utilized for driving the pickup head along the guide rod. The transmitting unit is assembled between the pickup head and the thread rod and has a seat and a movable element. Wherein, the seat is fixed on the pickup head and has at least a sliding way extending toward the thread rod, and the movable element is slidably assembled in the sliding way and has a rack located on a surface thereof facing the thread rod. The rack is engaged with the thread rod.

### BRIEF DESCRIPTION OF THE DRAWINGS

The present invention will now be specified with reference to its preferred embodiment illustrated in the drawings, in which:

FIG. 1 is a schematic view of a typical pickup head transmitting mechanism;

FIG. 2 is an enlarged view of the transmitting unit in FIG. 1;

FIG. 3 is a schematic view showing the rack of the transmitting unit escaping the thread rod;

FIG. 4 is a schematic view of another typical pickup head transmitting mechanism;

FIG. 5 is a schematic view of a preferred embodiment of the pickup head transmitting mechanism in accordance with the present invention;

FIGS. 6A and 6B are enlarged views of different viewing angles showing the transmitting unit in FIG. 5; and

FIG. 7 is a schematic view showing the assembling process of the transmitting unit in accordance with the present invention.

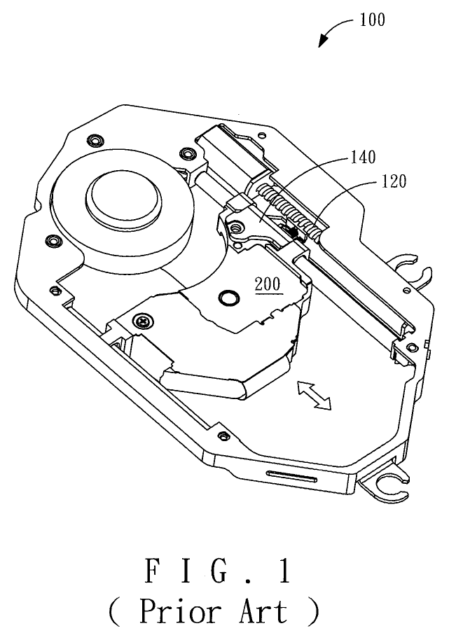

### DESCRIPTION OF THE PREFERRED EMBODIMENT

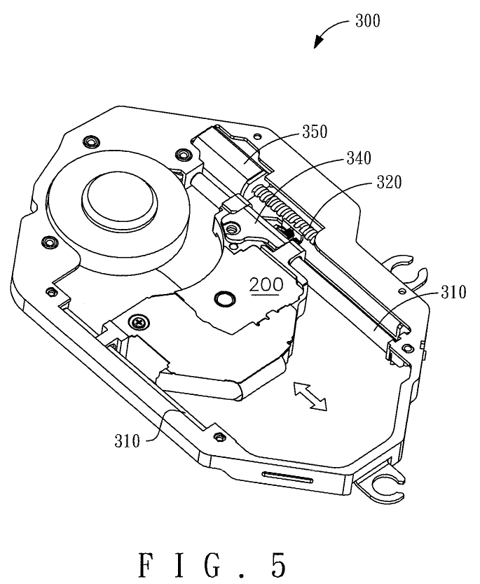

FIG. 5 is a schematic view of a preferred embodiment of a pickup head transmitting mechanism 300 of a disc drive in accordance with the present invention. As shown, the pickup head transmitting mechanism 300 has at least a guide rod 310, a thread rod 320, and a transmitting unit 340. Two guide rods 310 parallel with each other are shown in the present embodiment. The guide rods 310 are utilized for supporting the pickup head 200 of the disc drive. One of the two ends of the thread rod 320 is mechanically connected to a motor 350, such as a stepping motor. The motor 350 rotates the thread rod 320. The extending direction of the thread rod 320 is substantially parallel to the extending direction of the guide rod 310. The transmitting unit 340 is assembled between the pickup head 200 and the thread rod 320 for transforming rotational movements of the thread rod 320 into linear movements to drive the pickup head 320. Thereby, the motor 350 may drive the pickup head 200 moving linearly along the guide rod 310 by using the thread rod 320 and the transmitting unit 340.

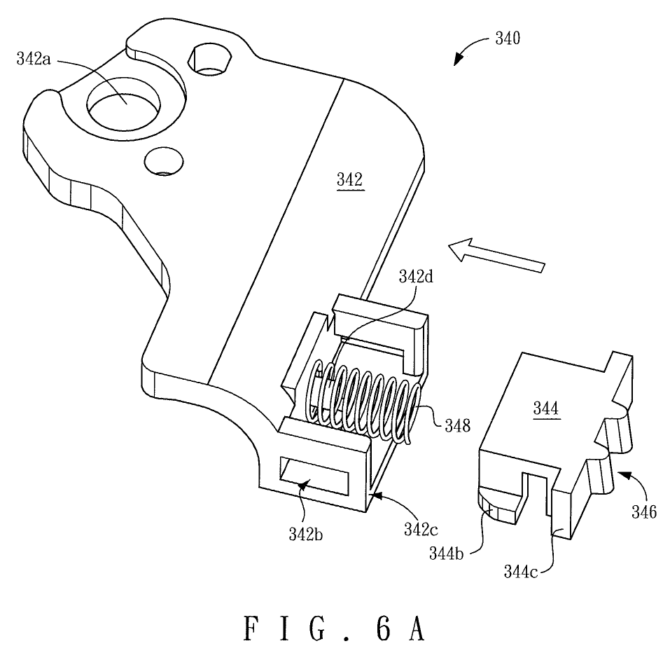

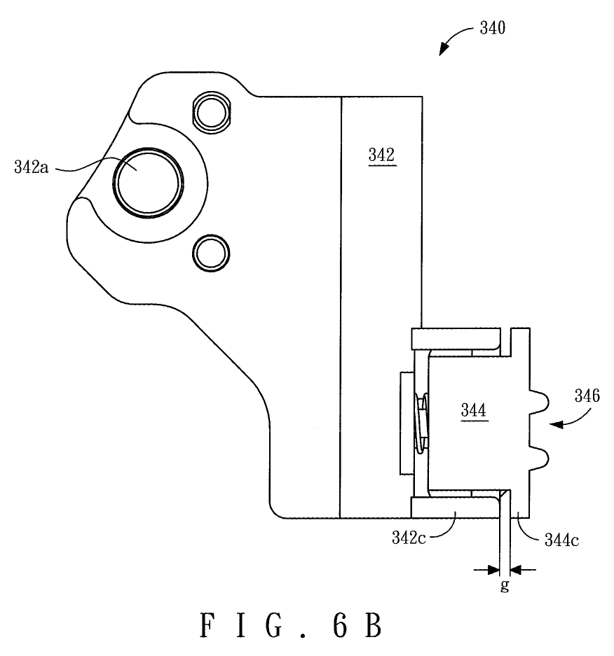

FIGS. 6A and 6B are enlarged views showing the transmitting unit 340 of FIG. 5. As shown, the transmitting unit 340 is divided into a seat 342 and a movable element 344, which are two separated elements. Wherein, the seat 342 has a fixing hole 342a. The seat 342 is fixed to a side of the pickup head 200 close to the thread rod 320 by using the fixing hole 342a. In addition, the seat 342 has at least a sliding way 342b extending toward the thread rod 320. The movable element 344 is locked in the sliding way 342b but is still slidable in the sliding way 342b. As a preferred embodiment, the seat 342 and the movable element 344 may be fabricated by injection molding.

Referring to FIG. 6A, the movable element 344 has at least a locker 344b corresponding to the sliding ways 342b on the seat 342. The locker 344b may be a clamp grasping the edge of the sliding way 342b for locking the movable element 344 to the sliding way 342b. It is noted that the function of the locker 344b is to prevent the movable element 344 from leaving the sliding way 342b, but is not to fix the movable element 344 at a precise location. The locker 344b is still movable along the sliding way 342b. Moreover, as an embodiment, there may be two sliding ways 342b formed on the seat 342 corresponding to the opposite sides of the movable element 344. The movable element 344 has two lockers 344b formed on the opposite side thereof to ensure that the movement of the movable element 344 is kept along the extending direction of the sliding way 342b.

The movable element 344 has a rack 346 on a surface thereof facing the thread rod 320. The rack 346 is utilized for engaging with thread on the thread rod 320. It is noted that thread depth of the rack 346 should be greater than that of the thread on the thread rod 320. Moreover, referring to FIGS. 6A and 6B, the movable element 344 has a stopping board 344c and the seat 342 has a respective stopper 342c. The stopping board 344c and the stopper 342c are utilized for restricting a movable range of the movable element 344 with respect to the seat 342 so as to prevent the rack 346 from escaping the thread rod 320. When the movable element 344 is assembled to the seat 342, the rack 346 on the movable element 344 is engaged with the thread rod 320 and a changeable gap g between the stopping board 344c and the stopper 342c with a size substantially located in the movable range of the movable element 344 along the sliding way 342b with respect to the seat 342 is given. As a preferred embodiment, maximum of the changeable gap g is not greater than thread depth of the thread rod 320 so as to restrict the movable range of the movable element 344 with respect to the seat 342 being no greater than thread depth of the thread rod 320.

It is noted that the embodiment shown in FIGS. 6A and 6B featuring a stopping board 344c and a stopper 342c for restricting the movable range of the movable element 344 with respect to the seat 342. However, it should not be a limitation to the present invention. For example, the movable range of the movable element 344 with respect to the seat 342 may be restricted by adjusting the location and length of the sliding way 342b on the seat 342.

In addition, in the embodiment shown in FIGS. 6A and 6B, the stopping board 344c is located on a side of the movable element 344 away from the seat 342, and the respective stopper 342c is extended from the base of the seat 342 toward the thread rod 320. However, the location of the stopping board 344c should not be a limitation to the present invention. What is important is that the changeable gap between the stopping board 344c and the stopper 342c is kept to be no greater than the thread depth of the thread rod 320.

Furthermore, referring to FIGS. 6A and 6B, an elastic unit 348 is assembled between the seat 342 and the movable element 344 for providing a preload to the movable element 344 to press the rack 346 toward the thread rod 320 and prevent the rack 346 from escaping the thread rod 320. The elastic unit 348 may be a compressed spring or an elastic plate. In addition, referring to FIG. 6A, the seat 342 has a positioning pin 342d extending toward the movable element 344 for positioning the elastic unit 348 and locating the elastic unit 348.

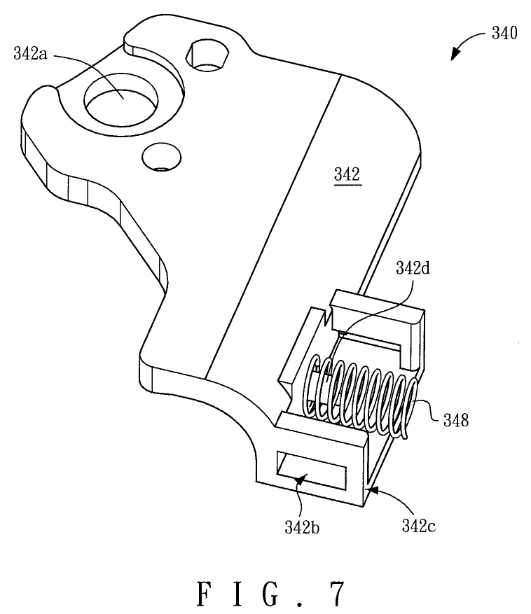

Since the transmitting unit 340 is divided into the seat 342 and the movable element 344, in the assembling process shown in FIG. 7, the elastic unit 348 should be firstly located on the positioning pin 342d of the seat 342, and then, referring to FIG. 6A, the lockers 344b of the movable element 344 are locked in the sliding ways 342b of the seat 342 to finish the assembling process.

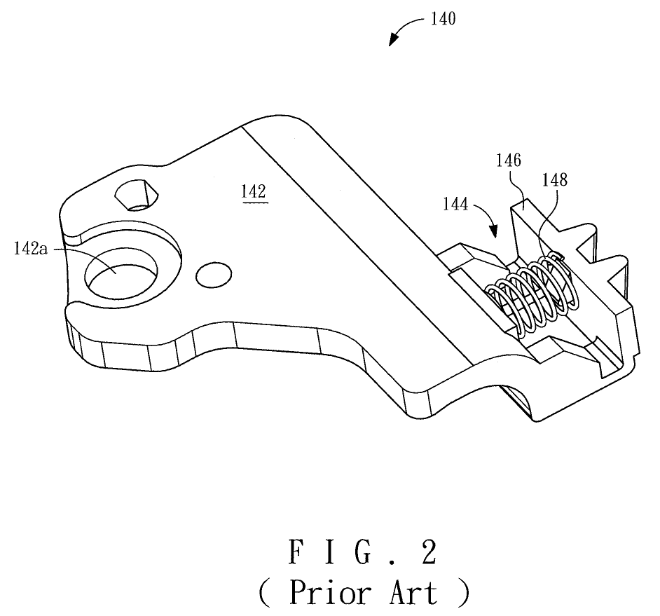

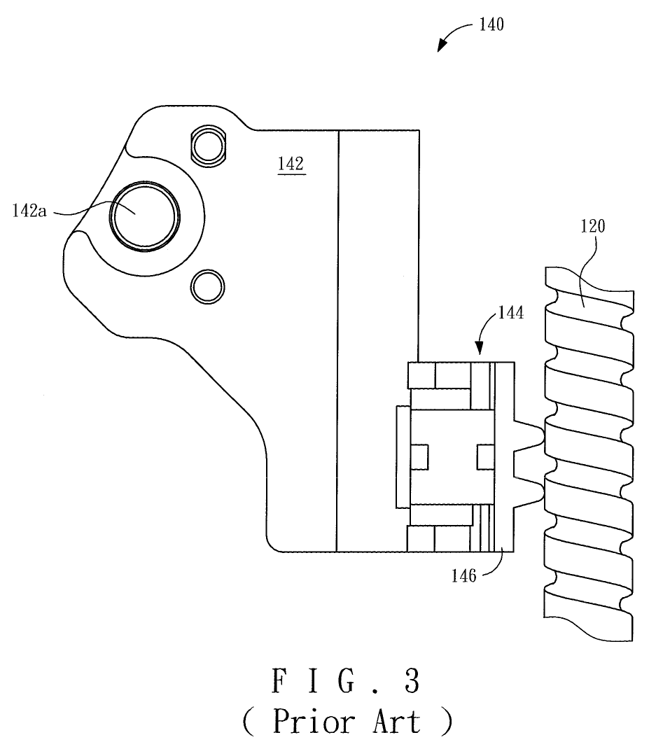

Referring to FIG. 2, the typical transmitting unit 140 is fabricated as a whole by using plastic materials and has an elastic arm 144 located between the main body 142 and the rack 146. Referring to FIG. 3, as the rack 146 escapes the thread rod 120, the elastic arm 144 is over-bended to generate permanent deformation. As a result, the rack 146 could not return to its original position to be engaged with the thread rod 120 and the seeking function of the pickup head 200 may be lost. In contrast, referring to FIGS. 6A and 6B, the seat 342 and the movable element 344 of the transmitting unit 340 are separated with each other and there has no elastic arm 144 located between the seat 342 and the movable element 344. Thus, the problem due to the permanent deformation of the elastic arm 144 may be prevented.

In addition, referring to FIGS. 2 and 3, the typical method for restricting the retraction distance of the rack 146 to prevent the rack 146 from escaping the thread rod 120 is to change the gap between the rack 146 and the main body 142. However, a smaller gap implies an enhancement of fabrication difficulty during the injection molding process and the increasing of attrition rate of the mold. In contrast, referring to FIGS. 6A and 6B, the transmitting unit 340 in accordance with the present invention features the stopper 342c on the seat 342 and the stopping board 344c on the movable element 344 to restrict the retraction distance of the rack 346. Therefore, the transmitting unit 340 has the potential to prevent the rack 346 from escaping the thread rod 320. In addition, because the seat 342 and the movable element 344 are molded separately, the problem due to the small gap between the stopper 342c and the stopping board 344c does not exist in the present invention.

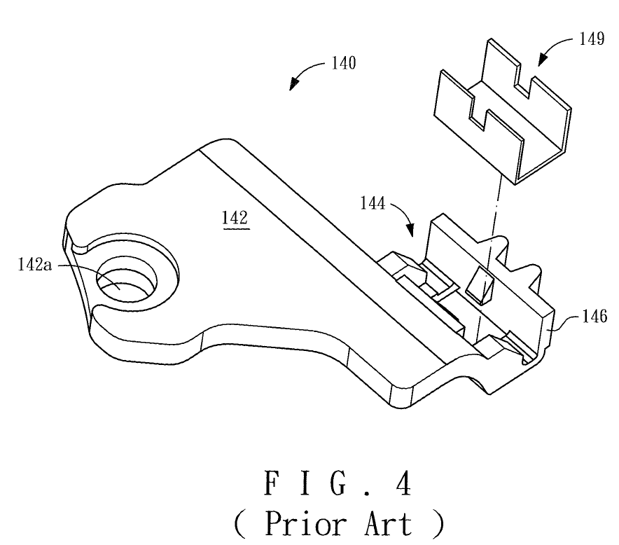

In addition, referring to FIG. 2, the compressed spring 148 provided in the typical transmitting unit 140, which is utilized for generating a preload to the rack 146, cannot prevent the rack 146 from escaping the thread rod 120. Furthermore, referring to FIG. 4, although the typical method of assembling the elastic plate 149 by the elastic arm 144 may prevent the rack 146 from escaping the thread rod 120, it has a side effect that the elastic arm 144 would be broken when an impact is applied thereon. In contrast, referring to FIGS. 6A and 6B, the seat 342 and the movable element 344 of the transmitting unit 340 are separated with each other and there has no elastic arm 144 located between the seat 342 and the movable element 344.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A pickup head transmitting mechanism of a disc drive comprising:
at least a guide rod, for supporting a pickup head;
a thread rod, for driving the pickup head along the guide rod; and
a transmitting unit, assembled between the pickup head and the thread rod, the transmitting unit comprising:
a seat, fixed on the pickup head, and having at least a sliding way extending toward the thread rod; and
a movable element, slidably assembled to the sliding way and having a rack engaged with the thread rod.

2. The pickup head transmitting mechanism of claim 1, wherein a movable range of the movable element with respect to the seat is not greater than a depth of threads on the thread rod.

3. The pickup head transmitting mechanism of claim 1, further comprising an elastic unit assembled between the seat and the movable element for pressing the rack toward the thread rod.

4. The pickup head transmitting mechanism of claim 3, wherein the elastic unit is a compressed spring.

5. The pickup head transmitting mechanism of claim 3, wherein the seat has a positioning pin for positioning the elastic unit.

6. The pickup head transmitting mechanism of claim 1, wherein the movable element has a stopping board, the seat has a respective stopper, wherein the stopping board and the stopper are utilized for restricting a movable range of the movable element with respect to the seat.

7. The pickup head transmitting mechanism of claim 6, wherein size of a changeable gap between the stopping board and the stopper is substantially located in the movable range of the movable element with respect to the seat.

8. The pickup head transmitting mechanism of claim 1, wherein the movable element has at least a locker slidably assembled in the sliding way for locking the movable element to the sliding way.

9. The pickup head transmitting mechanism of claim 8, wherein the movable element has two lockers located on opposite sides thereof, and the seat has two sliding ways corresponding to the two lockers.

10. The pickup head transmitting mechanism of claim 1, wherein a number of the guide rod is two.

11. The pickup head transmitting mechanism of claim 1, wherein the transmitting unit is fabricated by using plastic materials.

12. The pickup head transmitting mechanism of claim 1, wherein a thread depth of the rack is greater than a thread depth of the thread rod.

13. The pickup head transmitting mechanism of claim 1, wherein the seat is fixed to a side of the pickup head close to the thread rod.
